(19) United States
(12) Patent Application Publication
(10) Pub. No.: US 2015/0171459 A1
(43) Pub. Date: Jun. 18, 2015

(54) FUEL CELL STACK WITH ENHANCED SEAL

(71) Applicant: DELPHI TECHNOLOGIES, INC., TROY, MI (US)

(72) Inventor: KARL J. HALTINER, Jr., FAIRPORT, NY (US)

(21) Appl. No.: 14/105,504

(22) Filed: Dec. 13, 2013

(51) Int. Cl. H01M 8/24

(52) U.S. Cl. CPC H01M 8/2485

(57) ABSTRACT

A fuel cell stack assembly is disclosed. The fuel stack assembly includes first and second fuel cell cassettes joined together by an electrically insulating seal material, with the seal material disposed in a first seal retaining area between a recessed portion of the first cassette and a protruding portion of the second cassette.

### RELATIONSHIP TO GOVERNMENT CONTRACTS

This invention was made with Government support under DE-NT003894 or DE-FC26-02NT41246 awarded by DOE. The Government has certain rights in this invention.

### BACKGROUND OF THE INVENTION

In practical fuel cell systems, the output of a single fuel cell is typically less than one volt, so connecting multiple cells in series is required to achieve useful operating voltages. Typically, a plurality of fuel cell stages, each stage comprising a single fuel cell unit, are mechanically stacked up in a “stack” and are electrically connected in series electric flow from the anode of one cell to the cathode of an adjacent cell via intermediate stack elements known in the art as interconnects and separator plates.

A solid oxide fuel cell (SOFC) comprises a cathode layer, an electrolyte layer formed of a solid oxide bonded to the cathode layer, and an anode layer bonded to the electrolyte layer on a side opposite from the cathode layer. In use of the cell, air is passed over the surface of the cathode layer, and oxygen from the air migrates through the electrolyte layer and reacts in the anode with hydrogen being passed over the anode surface, forming water and thereby creating an electrical potential between the anode and the cathode of about 1 volt. Typically, each individual fuel cell is mounted, for handling, protection, and assembly into a stack, within a metal frame referred to in the art as a “picture frame”, to form a “cell-picture frame assembly”.

To facilitate formation of a stack of fuel cell stages wherein the voltage formed is a function of the number of fuel cells in the stack, connected in series, a known intermediate process for forming an individual fuel cell stage joins together a cell-picture frame assembly with an anode interconnect and a metal separator plate to form an intermediate structure known in the art as a fuel cell cassette (“cassette”). The thin sheet metal separator plate is stamped and formed to provide, when joined to the mating cell frame and anode spacers, a flow space for the anode gas. Typically, the separator plate is formed of ferritic stainless steel for low cost. In forming the stack, the cell-picture frame assembly of each cassette is sealed to the perimeter of the metal separator plate of the adjacent cassette to form a cathode air flow space and to seal the feed and exhaust passages for air and hydrogen against cross-leaking or leaking to the outside of the stack.

The separator plate provides for fluid flow separation between the anode and cathode of adjacent cells in the fuel cell stack, and also provides part of an electrically conductive path connecting the anode from one cell in series with the cathode of an adjacent cell. In some fuel cell stack designs, the separator plate itself is configured on one or both sides to provide a three-dimensional structure that provides contact with the electrode of an adjacent fuel cell at a number of locations so that electrical connectivity, with spaces between the points of contact so that fluid (air or fuel) can flow along the surface of the electrode. In other designs, a separate interconnect structure is disposed in the stack between separator plate and the adjacent fuel cell(s).

The cells in a fuel cell stack are electrically connected in series from the anode of one cell through the electrically conductive separator plate to the cathode of an adjacent cell. Electrical contact between the separator plate and the cathode and anode of adjacent cells is typically provided at discrete points of contact the adjacent electrodes with spaces between the points of contact to allow for fluid flow. The points of contact can be provided in various ways, such as by the physical configuration of the separator plate itself (e.g., dimples or ridges) or by interconnect elements disposed between the separator plate and each of the adjacent electrodes. The fuel cell stack is typically sealed along the periphery to contain the fuel and air flows within the stack. However, in order to preclude short circuits around the series connection of the cells through the separator plates, the peripheral seal between adjacent cassettes is typically formed from an electrically insulating seal material such as a glass ceramic.

Typical seals utilized for SOFC stack sealing applications are formed from an alkaline earth aluminosilicate glass, such as a barium-calcium-aluminosilicate based glass, also known as G-18 glass, developed by Pacific Northwest National Laboratory (PNNL). G-18 glass provides a seal material that offers high electrical resistively, high coefficient of thermal expansion, high glass transition temperature, and good chemical stability. Another known type of seals for SOFC stack sealing applications are composite glass seals, which are formed from glass materials mixed with fibers to increase the structural integrity of the glass matrix. Viscous glasses, defined as any glass that remains in a fully or partially amorphous phase within the standard operating temperature of an SOFC stack of about 500° C. to 1000° C., and retains its ability to flow. Examples of viscous glass include B—Ge—Si—O glasses, which retains approximately 70% amorphous phase after 1500 hours at 850 [deg.]C; barium alkali silicate glass; and SCN-1 glass, commercially available from SEM-COM Company, Inc.

Glass ceramic seals are typically sandwiched between two planar surfaces parallel to the plane of the mounted fuel cell. The stack assembly is restrained and/or loaded in the direction perpendicular to the planar fuel cells and the seals to reduce tensile stresses in the seal joint, which ideally results in compressive stress perpendicular to seal/fuel cell plane. This can be beneficial because seal materials such as glass ceramic are often lowest in strength to tensile stress, but highest in strength to compressive stress. Although compressive loading of the fuel cell stack can reduce tensile stresses to which the seal joints are subjected, such loading has no effect on shear stresses within the plane of the seal joint. Although the shear strength of seal materials such as glass ceramic is stronger than tensile strength, it is often not strong enough to meet operational requirements, particularly those experienced during thermal cycling.

Based on the foregoing and other factors, there remains a need for different alternatives for seal joints in fuel cell stacks.

### SUMMARY OF THE INVENTION

The present invention provides a fuel cell stack assembly comprising first and second fuel cell cassettes joined together by an electrically insulating seal material wherein the seal material is disposed in a first seal retaining area between a recessed portion of the first cassette and a protruding portion of the second cassette.

In another aspect of the invention, the first fuel cell cassette comprises a first fuel cell retainer plate having a first fuel cell subassembly mounted in a central opening of the first cell retainer plate, and a first separator plate. The first separator plate and the first cell retainer plate are joined along mutual edge portions thereof and configured to enclose a first captive space having inlet and outlet openings thereto for fluid flow along a surface of the first fuel cell subassembly. The second fuel cell cassette comprises a second fuel cell retainer plate having a second fuel cell subassembly mounted in a central opening of the second cell retainer plate, and a second cell retainer plate joined along mutual edges thereof and configured to enclose a second captive space comprising having inlet and outlet openings thereto for fluid flow along a first surface of the second fuel cell subassembly. The first cassette and the second cassette are joined together along mutual edge portions of the first separator plate and the second cell retainer plate by an electrically insulating seal material, and are configured to enclose a third captive space having inlet and outlet openings thereto for fluid flow along a second surface of the second fuel cell subassembly.

In yet another aspect of the invention, a method of assembling a fuel cell stack comprises disposing an electrically insulating seal material in a first seal retaining area between a recessed portion of a first fuel cell cassette and a protruding portion of a second fuel cell second cassette, and curing the seal material.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is an exploded isometric view of a fuel cell cassette;

FIG. 2A depicts a top (cell retainer plate) view of a cassette from FIG. 1, with further detail of a seal retaining area;

FIG. 2B depicts a bottom (separator plate) view of a cassette from FIG. 1, with further detail of a seal retaining area;

FIG. 3 is a cross-section view taken along line A-A of a cell retainer plate of FIG. 2A joined to a separator plate of FIG. 2B from an adjacent fuel cell cassette;

FIG. 4 is a cross-section view taken along line B-B of the cell retainer plate of FIG. 3 joined to the separator plate of FIG. 4 from an adjacent fuel cell cassette.

### DETAILED DESCRIPTION

Referring now to the Figures, the invention will be described with reference to specific embodiments, without limiting same. Where practical, reference numbers for like components are commonly used among multiple figures.

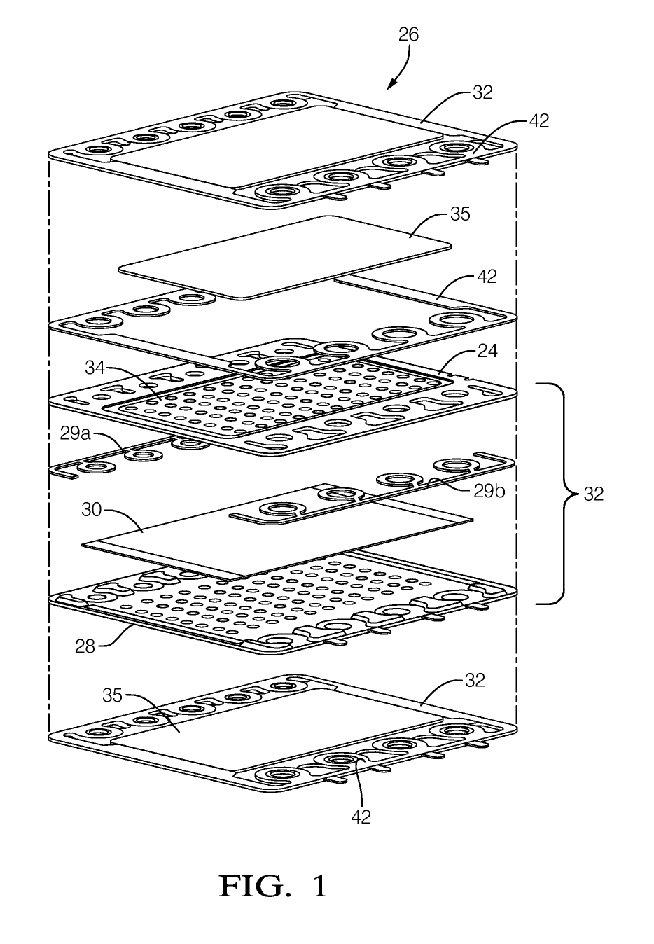

The invention is not limited to a particular cassette design or configuration, as it is directed to the electrically insulating seal between the cassettes, and the design and manufacture of the mating components on adjacent cassettes and the stack assembly. Referring to FIG. 1, an exemplary stack configuration is shown for a fuel cell such as a solid oxide fuel cell, where stack 26 of individual fuel cell are part of a series of cassettes 32 connected to provide a series electrical connection between individual fuel cells in the stack. Although the cassettes or portions thereof can be formed in any sort of stepwise process, including a layer by layer addition process where the individual elements of each cassette are added onto the stack one at a time. In some exemplary embodiments, it is efficient to assemble the cassettes or portions thereof first in an intermediate process, followed by joining them together to form a fuel cell stack. As shown in FIG. 1, a stack of three fuel cells housed in cassettes 32 is shown in exploded view, with the middle cassette shown in a more detailed exploded view. Each cassette 32 includes a cell frame assembly 24 with fuel cell retainer plate 27 having fuel cell 34 (cathode surface shown) mounted therein, anode spacers 29a and 29b, anode interconnect 30, and separator plate 28. The separator plate 28 can be formed from ferritic stainless steel for low cost. Separator plate 28 and cell retainer plate 27 can be stamped from sheet metal and/or other forming processes to provide, when joined to the mating cell frame 22 and inlet and outlet anode spacers 29a, 29b, a flow space for the anode gas. In this exemplary embodiment, a cathode interconnect 35 is installed during final assembly against cathode surface 34, and the cathode interconnect 35 together with the surrounding separator plate 28 and fuel cell 34 cathode surface from adjacent cassettes 32, provides a cathode air flow space. Also during the final stack assembly process, a glass perimeter and anode port seal 42 is disposed between adjacent cassettes 32, and the stack is heated and placed under load perpendicular to the plane of the fuel cells to distribute and cure or fuse the glass seal material. Any type of glass seal can be used, such as above-mentioned G-18 glass ceramic and others known in the art. In some exemplary embodiments, viscous glass (defined herein, viscous glass is any glass that remains in a fully or partial amorphous phase in the standard operating temperature of fuel cell stack, even after prolonged periods of exposure, and retains its ability to flow) can be used such as B—Ge—Si—O glasses; barium alkali silicate glass; and SCN-1 glass, commercially available from SEM-COM Company, Inc. The separator plate and cell frame can be designed to deform slightly so as to provide a compliant assembly, to help ensure that the cells and interconnects come to rest on one another under load. The stack is then allowed to cool and the load is removed.

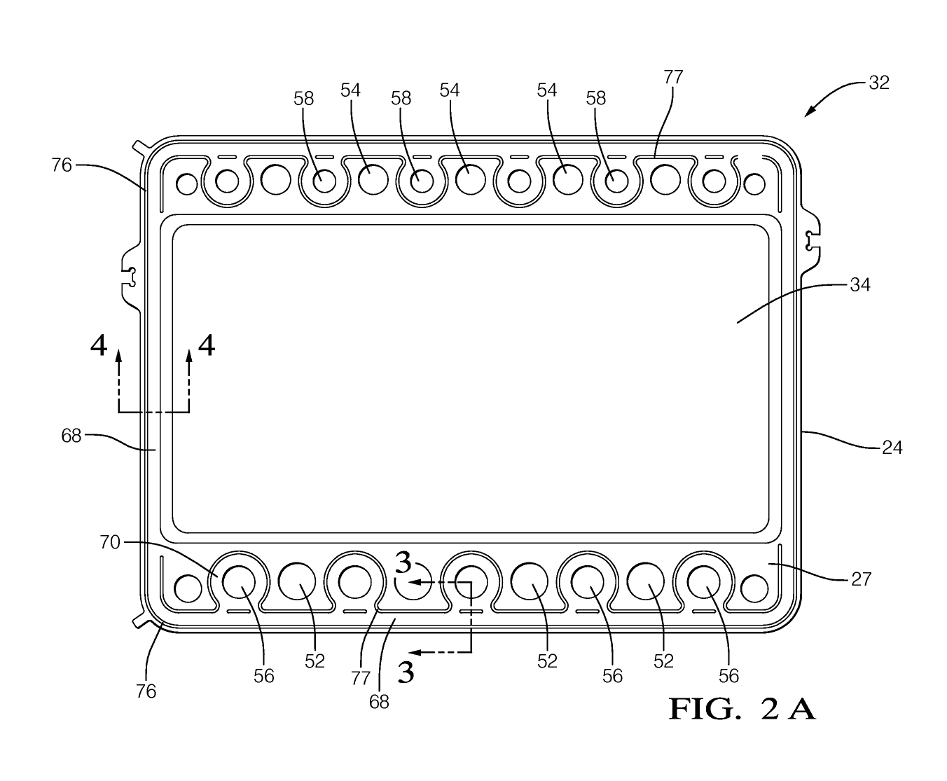

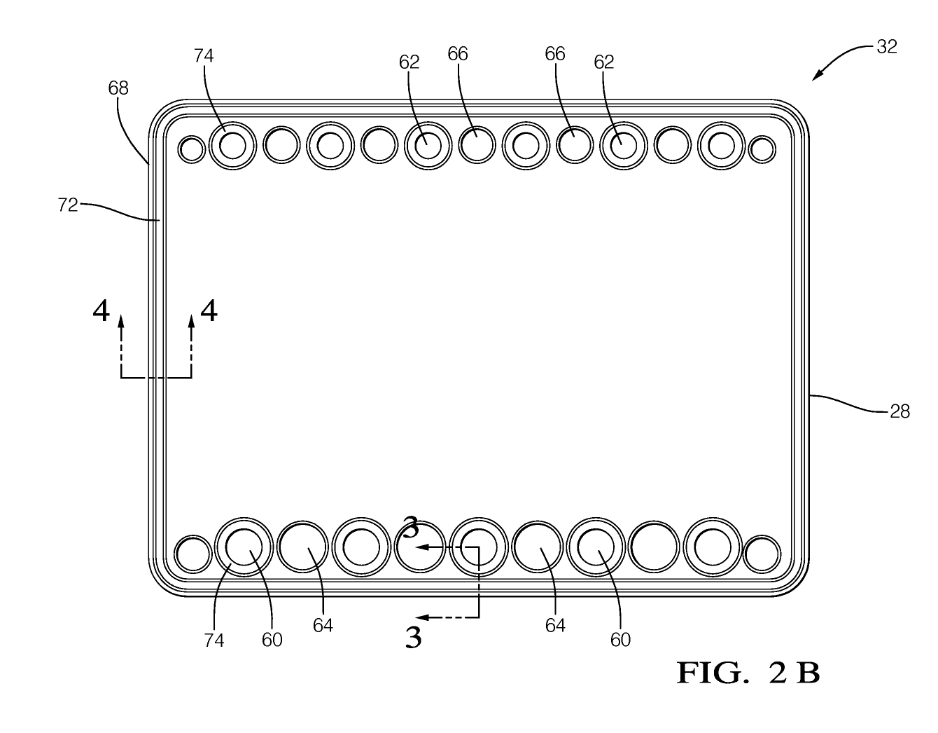

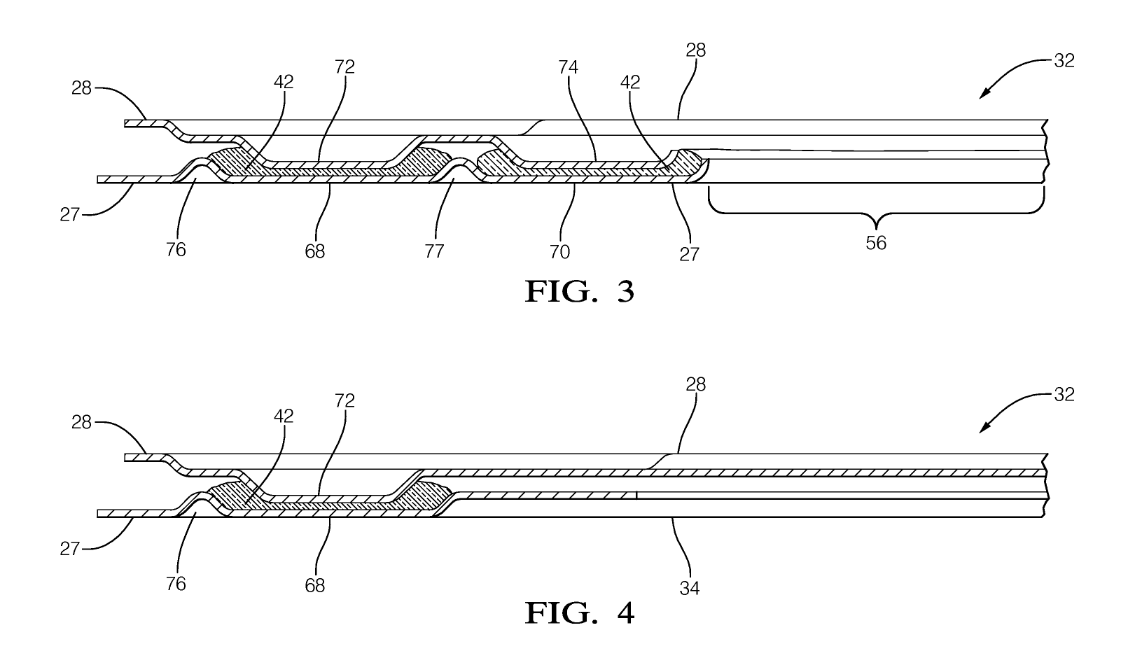

Referring now to FIGS. 2-4, which use the same numbering as FIG. 1 where applicable, FIG. 2A depicts a top (cell frame assembly 24) view of a cassette 32. The cell retainer plate 27 has air pass-through ports 54, exhaust air pass-through ports 52 , fuel inlets 58, and anode tail gas outlets 56. The separator plate 28 has fuel inlets 62, anode tail gas exhaust outlets 60, air pass-through ports 66, and exhaust air pass-through ports 64. As shown in FIGS. 2-4, cell retainer plate 27 and separator plate 28 from adjacent cassettes 32 form a retaining area for seal 42 disposed between recessed areas 68, 70 on the cell retainer plate 27 and the protruding areas 72, 74 on the separator plate 28. The terms “recessed” and “protruding” are with respect to an axis along the stack perpendicular to the plane of the fuel cells. Additionally, the terms “recessed” and “protruding” are intended to describe the configuration of portions of the components with respect to one another, and are not intended as a limitation on how such portions are formed. For example, the recessed portion 68 on the cell retainer plate 27 does not have to be subject to any deformation itself, but can instead be formed between protruding portions 76 and 77, which, like the protruding portions 72 and 74 on the separator plate 28, can be formed by sheet metal extrusion stamping.

The invention provides a robust configuration that is resistant to the deleterious effects of stress on the fuel cell stack structure. The sealing material is retained within a nested configuration between adjacent cassettes where at least a portion of the seal material is captured between opposing cassette surfaces that are perpendicular to or at a substantial angle to the plane of the fuel cell. This geometry can be easily produced inexpensively and reproducibly by stamping sheet metal parts (e.g., having thicknesses of from 0.10 mm to 0.75 mm) Additionally, this geometry can provide retention of viscous glasses, which have shown promise because of their ability to self-heal from cracks, but can be subject to flow-out at SOFC operating temperatures.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description.

1. A fuel cell stack assembly, comprising:
first and second fuel cell cassettes joined together by an electrically insulating seal material;
wherein the seal material is disposed in a first seal retaining area between a recessed portion of the first cassette and a protruding portion of the second cassette.

2. The fuel cell stack assembly of claim 1, wherein the recessed portion of the first cassette and the protruding portion of the second cassette are formed from stamped sheet metal.

3. The fuel cell stack assembly of claim 2, wherein first cassette comprises a protruding portion adjacent to the recessed portion, and the protruding portions on the first and second cassettes are formed by sheet metal extrusion.

4. The fuel cell stack assembly of claim 2, wherein first cassette comprises a protruding portion on each side of and adjacent to the recessed portion, and the protruding portions on the first and second cassettes are formed by sheet metal extrusion.

5. The fuel cell stack assembly of claim 1, wherein the protruding portion of the second cassette is in a nested configuration with the recessed portion of the first cassette.

6. The fuel cell stack assembly of claim 1, wherein the first seal retaining area extends around the periphery of the first and second cassettes.

7. The fuel cell stack assembly of claim 1, wherein the seal material is a glass ceramic.

8. The fuel cell stack assembly of claim 1, wherein the seal material is a viscous glass.

9. A fuel cell stack assembly, comprising
a first fuel cell cassette comprising a first fuel cell retainer plate having a first fuel cell subassembly mounted in a central opening of the first cell retainer plate, and a first separator plate, the first separator plate and the first cell retainer plate joined along mutual edge portions thereof and configured to enclose a first captive space having inlet and outlet openings thereto for fluid flow along a surface of the first fuel cell subassembly;
a second fuel cell cassette comprising a second fuel cell retainer plate having a second fuel cell subassembly mounted in a central opening of the second cell retainer plate, and a second separator plate, the second separator plate and the second cell retainer plate joined along mutual edges thereof and configured to enclose a second captive space comprising having inlet and outlet openings thereto for fluid flow along a first surface of the second fuel cell subassembly;
the first cassette and the second cassette joined together along mutual edge portions of the first separator plate and the second cell retainer plate by an electrically insulating seal material and configured to enclose a third captive space having inlet and outlet openings thereto for fluid flow along a second surface of the second fuel cell subassembly;
wherein the seal material is disposed in a first seal retaining area between a recessed portion of the first cassette and a protruding portion of the second cassette

10. The fuel cell stack assembly of claim 9, wherein first cassette comprises a protruding portion adjacent to the recessed portion, and the protruding portions on the first and second cassettes are formed by sheet metal extrusion.

11. The fuel cell stack assembly of claim 9, wherein first cassette comprises a protruding portion on each side of and adjacent to the recessed portion, and the protruding portions on the first and second cassettes are formed by sheet metal extrusion.

12. The fuel cell stack assembly of claim 9, wherein the protruding portion of the second cassette is in a nested configuration with the recessed portion of the first cassette.

13. The fuel cell stack assembly of claim 9, wherein the first separator plate comprises the protruding portion and the second cell retainer plate comprises the recessed portion.

14. The fuel cell stack assembly of claim 9, wherein the first seal retaining area extends around the periphery of the first and second cassettes.

15. The fuel cell stack assembly of claim 14, further comprising a second seal retaining area between the first and second fuel cell cassettes, surrounding said inlet and outlet openings.

16. The fuel cell stack assembly of claim 9, wherein the seal material is a glass ceramic.

17. The fuel cell stack assembly of claim 9, wherein the seal material is a viscous glass.

18. A method of assembling a fuel cell stack, comprising
disposing an electrically insulating seal material in a first seal retaining area between a recessed portion of a first fuel cell cassette and a protruding portion of a second fuel cell second cassette; and
curing the seal material.

19. The method of claim 18, further comprising stamping sheet metal components to form said recessed and protruding portions.

20. The method of claim 19, further comprising forming a protrusion adjacent to the recessed portion on the first cassette, and wherein the protruding portions on the first and second cassettes are formed by sheet metal extrusion.

21. The method of claim 19, further comprising forming protrusions on each side of the recessed portion on the first cassette, and wherein the protruding portions on the first and second cassettes are formed by sheet metal extrusion.
